(19) United States
(12) Patent Application Publication
(10) Pub. No.: US 2013/0337283 A1
(43) Pub. Date: Dec. 19, 2013

(54) Process For Joining Carbide And Non Carbide Materials And The Method Thereof

(71) Applicant: Kennametal lndia Limited, Bangalore (IN)

(72) Inventors: Raghavan Rengarajan, Bangalore (IN); Ramesh S. Rao, Bangalore (IN); Jagannath Vaishali, Mangalore (IN); Kuttan P. Pramodh, Bangalore (IN); Bhaskar Alok, Bangalore (IN); Gopalrao Rao Shivaram, Bangalore (IN); Shenoy K. Chandrashekar, Mangalore (IN)

(73) Assignee: Kennametal lndia Limited, Bangalore (IN)

(21) Appl. No.: 13/889,831

(22) Filed: May 8, 2013

(30) Foreign Application Priority Data
Jun. 14, 2012 (IN) 2377/CHE/2012

(51) Int. Cl. B23K 31/02; B32B 15/04; B32B 5/16

(52) U.S. Cl. CPC B23K 31/02; B32B 5/16; B32B 15/043
USPC 428/557; 228/122.1; 228/124.1

(57) ABSTRACT

In one embodiment, a process for joining carbide and non-carbide materials is disclosed, the process comprising providing an interface binder material, positioning the interface binder material between the carbide material and non-carbide material to provide an assembly and heating the assembly to join the carbide material and non-carbide material through the interface binder material, wherein the interface binder material comprises a powder metal or powder alloy or a sheet of metal or alloy.

### RELATED APPLICATION DATA

The present application claims priority pursuant to 35 U.S.C. §119 to Indian Patent Application Number 2377/CHE/2012, filed Jun. 14, 2012, which is hereby incorporated by reference in its entirety.

### TECHNICAL FIELD

The present disclosure relates to the joining of a hard powder metallurgical surface in compact or wrought form to a powder/wrought non carbide metal surface and more particularly relates to joining carbide and non carbide materials with the help of intermediate interface material by a brazing process.

### BACKGROUND OF DISCLOSURE

In most sintering processes, powdered material is positioned in a mold and heated to a temperature below the melting point of the material, thereby fusing the particles and creating a singular solid piece. Because the sintering temperature is not required to reach the melting point of the material, sintering is often chosen as the shaping process for materials with high melting-points such as tungsten and molybdenum.

Further, sintering is an effective process operable to enhance material properties such as strength, electrical conductivity, translucency and thermal conductivity. However, existing sintering processes have several limitations. For example, sintering of powder materials at high temperatures can alter the properties of the materials, including inducement of undesirable phase transformations in the materials. Further, sintering at lower temperatures often leads to the formation of interfacial porosity. Interfacial porosity is also evident when sintering materials of divergent composition. Interfacial porosity can weaken the mechanical integrity of the sintered product, leading to premature degradation and/or failure of the product.

### SUMMARY OF THE DISCLOSURE

In one aspect, processes are described herein operable to mitigate or overcome one or more disadvantages of prior techniques for joining compositionally divergent materials by sintering. Elements, apparatus and methods described herein, however, are not limited to the specific embodiments presented herein. It should be recognized that these embodiments are merely illustrative of the principles of the present invention. Numerous modifications and adaptations will be readily apparent to those of skill in the art without departing from the spirit and scope of the invention.

In one embodiment, a process for joining carbide and non-carbide materials is disclosed, the process comprising providing an interface binder material, positioning the interface binder material between the carbide material and non-carbide material to provide an assembly and heating the assembly to join the carbide material and non-carbide material through the interface binder material, wherein the interface binder material comprises a powder metal or powder alloy compact or a sheet of metal or alloy. The assembly, in some embodiments, is heated to a temperature ranging from 1000° C. to 1250° C. In some embodiments, the assembly is heated under vacuum or inert gas atmosphere. Further, in some embodiments, the assembly is subjected to hot isostatic pressing (hipping process) when joining the carbide and non-carbide materials. The joined carbide and non-carbide materials can be ground for obtaining the desired dimensions.

In some embodiments of a process for joining carbide and non-carbide materials described herein, the carbide material comprises tungsten carbide (WC). The carbide material in some embodiments comprises a cobalt or cobalt alloy binder yielding cemented carbide when sintered. A cobalt alloy binder can include alloying elements of nickel, chromium or combinations thereof. Other carbide species of transition metals selected from Groups IVB, VB and VIB of the Periodic Table can be included in the carbide material.

In some embodiments of a process for joining carbide and non-carbide materials described herein, the non-carbide material is steel. Steel, in some embodiments, is selected from the group consisting of tool steel, high speed steel (HSS) and cast iron. The non-carbide material, in some embodiments, comprises a high temperature alloy or super alloy.

In some embodiments, the metal or alloy (powder or sheet) of the interface binder material is selected from the group consisting of copper, silver, nickel, manganese, zinc, tin, cadmium, gold and palladium and alloys thereof. In one embodiment, for example, a metal of the interface binder material is copper.

In another aspect, a product comprising a carbide material joined to a non-carbide material is described herein. A product, in some embodiments, comprises a carbide material joined to a non-carbide material by a layer of metal or alloy interface binder material, wherein a first interfacial transition region is present between the carbide material and layer of metal or alloy interface binder material and/or a second interfacial transition region is present between the non-carbide material and layer of interface binder material. Interfacial transition regions of products and processes described herein, in some embodiments, have a structure different from each layer forming the transition regions.

Products of joined carbide and non-carbide having the forgoing structure can be produced according to methods described herein. For example, a product described herein, in one embodiment, is produced by a process comprising providing an interface binder material, positioning the interface binder material between the carbide and non-carbide materials to provide an assembly and heating the assembly to join the carbide material and non-carbide material through the interface binder material, wherein the interface binder material comprises a powder metal or powder alloy compact or a sheet of metal or alloy. The assembly, in some embodiments, is heated to a temperature ranging from 1000° C. to 1250° C. Further, in some embodiments, the assembly is subjected to hot isostatic pressing (hipping process) when joining the carbide and non-carbide materials. The joined carbide and non-carbide material can be ground for obtaining the desired dimensions.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The novel features and characteristics of the disclosure are set forth in the appended claims. The disclosure itself, however, as well as a preferred mode of use, further objectives and advantages thereof, will best be understood by reference to the following detailed description of an illustrative embodiment when read in conjunction with the accompanying figures. One or more embodiments are now described, by way of example only, with reference to the accompanying figures.

FIG. 1 illustrates assembly formation and heating to join carbide and non-carbide materials with a metal or alloy interface binder material according to one embodiment described herein.

FIG. 2(A) is a cross-section metallography of joined carbide and non-carbide materials according to one embodiment described herein.

FIG. 2(B) is a cross-section metallography of joined carbide and non-carbide materials according to one embodiment described herein.

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION OF DISCLOSURE

The foregoing has broadly outlined the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure. It will be readily understood that the aspects of the present disclosure, as generally described herein, and illustrated in the figures, can be arranged, substituted, combined, and designed in a wide variety of different configurations, all of which are explicitly contemplated and make part of this disclosure.

Referring now to the drawings wherein the drawings are for the purpose of illustrating exemplary embodiments of the disclosure only, and not for the purpose of limiting the same.

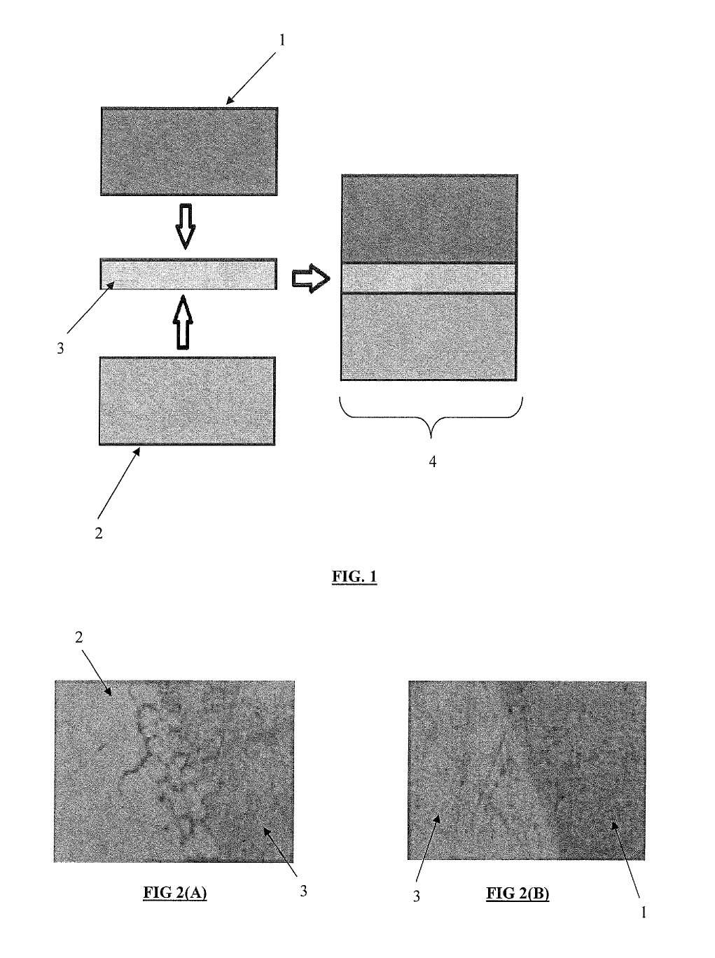

FIG. 1 illustrates assembly formation and heating to join carbide and non-carbide materials with a metal or alloy interface binder material according to one embodiment described herein. As illustrated in FIG. 1, carbide (1) and non-carbide (2) materials are provided. The carbide material (1), in some embodiments, comprises WC and a binder metal or alloy to provide cemented carbide when sintered. In some embodiments, WC is present in the carbide material (1) in an amount of at least 80 weight percent or in an amount of at least 85 weight percent. Cemented WC, in one embodiment, comprises a cobalt or cobalt alloy binder. A cobalt alloy binder can include alloying elements of nickel, chromium or combinations thereof. A cobalt or cobalt alloy binder, in some embodiments, is present in an amount ranging from 3 weight percent to 30 weight percent. The carbide material (1), in some embodiments, further comprises one or more of the following elements and/or their compounds: titanium, niobium, vanadium, tantalum, chromium, zirconium and/or hafnium. In some embodiments, titanium, niobium, vanadium, tantalum, chromium, zirconium and/or hafnium form solid solution carbides with the WC in the carbide material. The carbide material (1), in some embodiments, comprises one or more solid solution carbides in an amount ranging from 0.1 to 5 weight percent. Additionally, the carbide material (1) may contain nitrogen.

The non-carbide material (2), in some embodiments, is steel. In one embodiment, steel is selected from the group consisting of tool steel, HSS and cast iron. The non-carbide material (2), in some embodiments, is a high temperature alloy or super alloy.

An interface binder material (3) is positioned between the carbide material (1) and the non-carbide material (2) to provide an assembly (4), wherein the interface binder material comprises a powder metal or powder alloy compact or a sheet of metal or alloy. In some embodiments, the interface binder material (3) is in direct contact with the carbide material (1) and/or non-carbide material (2). The metal or alloy in powder or sheet form of the interface binder material (3), in some embodiments, is selected from the group consisting of Cu, Ag, Ni, Mn, Zn, Sn, Cd, Au and Pd and alloys thereof, In one embodiment, for example, a metal of the interface binder material is copper. In some embodiments, an alloy composition of the interface binder material is a copper based alloy. Suitable copper-based alloys can comprise additive elements of nickel (0-15%), manganese (0-40%), cobalt (0-10%) and zinc (0-50%) as well other elements including cadmium, boron and silicon. A powder alloy composition, in some embodiments, is a silver based alloy. Suitable silver based alloys can comprise additive elements of copper (0-50%), zinc (0-40%), tin (0-10%), nickel (0-10%) and manganese (0-20%).

An interface binder material in powder or sheet form can have any desired thickness. In some embodiments, an interface binder material has a thickness ranging from 0.3 mm to 10 mm or from 0.5 mm to 10 mm. An interface binder material, in some embodiments, has a thickness ranging from 1 mm to 10 mm or from 2 mm to 10 mm.

Metal or alloy compositional identity and thickness of the interface binder material for a joining process described herein can be selected according to several considerations including dimensions and compositional identities of the carbide and non-carbide materials to be joined. In one embodiment, for example, a carbide material comprising several transition metal carbides, such as TaC, ZrC, NbC and/or WC, can require a metal or alloy interface binder material divergent from a carbide material of WC alone.

The interface binder material (3), in some embodiments, is compacted with or on a surface of the carbide material (1) in a layered format. In some embodiments, the interface binder material (3) is compacted separately from the carbide material (1) and the non-carbide material (2). When compacted separately, the interface binder material (3) can be first associated with the carbide material (1) or non-carbide material (2) when forming the assembly (4).

The interface binder material (3), in some embodiments, has lateral dimensions commensurate with the face of the carbide material (1) and/or face of the non-carbide material (2) to be joined. Alternatively, in some embodiments, the interface binder material (3) has lateral dimensions incommensurate with the faces of the carbide material (1) and non-carbide material (2) to be joined. In one embodiment, for example, the lateral dimensions of the interface binder material (3) are smaller than the face of the carbide material (1) and/or face of the non-carbide material (2) to be joined.

The assembly (4) is heated to join the carbide material (1) and the non-carbide material (2) through the interface binder material (3). In some embodiments, the assembly is heated at a temperature ranging from 1000° C. to 1250° C. Heating the assembly (4) provides a fully dense or substantially fully dense metal or alloy binder layer adhering the non-carbide material (2) to the carbide material (1). In some embodiments, heating the assembly (4) melts the metal or alloy of the interface binder material (3) to provide the fully dense or substantially fully dense metal or alloy binder layer. In some embodiments wherein the metal or alloy is in powder form, heating the assembly sinters the powder metal or powder alloy of the interface binder material (3) to provide the fully dense or substantially fully dense metal or alloy binder layer. The assembly (4), in some embodiments, is heated under vacuum conditions in a vacuum furnace. In some embodiments, the assembly (4) is heated in an inert atmosphere, such as argon or other inert gas. Additionally, in some embodiments, the assembly (4) is also subjected to hipping to provide further densification of the binder layer. In some embodiments, hipping is administered simultaneously with heating the assembly (4) to the desired temperature. In other embodiments, hipping is administered subsequent to heating the assembly (4).

A first interfacial transition region, in some embodiments, is established between the carbide material (1) and the fully dense or substantially fully dense interface binder material (3). Further, in some embodiments, a second interfacial transition region is established between the non-carbide material (2) and the fully dense or substantially fully dense interface binder material (3). In some embodiments, each interfacial transition region has a thickness ranging from 1 μm to 200 μm or from 5 μm to 100 μm. One or both first and second interfacial transition regions can be present in the joined carbide (1) and non-carbide (2) composition.

In some embodiments, interfacial porosity is not present between the carbide material (1) and metal or alloy layer of the interface binder material (3). In some embodiments, interfacial porosity is not present between the non-carbide material (2) and metal or alloy layer of the interface binder material (3).

The joined carbide (1) and non-carbide (2) materials, in some embodiments, are subjected to heat treatment in an inert atmosphere for increasing the hardness of the non-carbide material (2). Further, the joined carbide material (1) and non-carbide material (2) can be ground and/or profiled to the desired dimension(s). In some embodiments, interface binder material (3) flowing out of the joint formed between the carbide (1) and non-carbide (2) materials is ground away to provide a smooth surface.

Products comprising carbide and non-carbide materials joined according to processes described herein, in some embodiments, demonstrate interfacial shear strength (transverse rupture strength) of at least 200 MPa. In some embodiments, the products demonstrate interfacial shear strength ranging from 200 MPa to 600 MPa. Products produced according to processes described herein, in some embodiments, demonstrate interfacial shear strength ranging from 250 MPa to 550 MPa or from 300 MPa to 500 MPa. Interfacial shear strength is determined according to ISO 3327-2009.

In another aspect, a product comprising a carbide material joined to a non-carbide material is described herein. A product, in some embodiments, comprises a carbide material joined to a non-carbide material by a layer of metal or alloy interface binder material, wherein a first interfacial transition region is present between the carbide material and the layer of metal or alloy interface binder material and/or a second interfacial transition region is present between the non-carbide material and the layer of interface binder material. In some embodiments, an interfacial transition region is only present between the non-carbide material and the layer of interface binder material. In some embodiments, each interfacial transition region has a thickness ranging from 1 μm to 200 μm or from 5 μm to 100 μm.

In some embodiments, a product described herein does not demonstrate interfacial porosity between the carbide material and metal or alloy layer of the interface binder material. In some embodiments, a product does not demonstrate interfacial porosity between the non-carbide material and metal or alloy layer of the interface binder material.

Products comprising joined carbide and non-carbide materials described herein, in some embodiments, demonstrate interfacial shear strength (transverse rupture strength) of at least 200 MPa. In some embodiments, the products demonstrate interfacial shear strength ranging from 200 MPa to 600 MPa. Products described herein, in some embodiments, demonstrate interfacial shear strength ranging from 250 MPa to 550 MPa or from 300 MPa to 500 MPa. Interfacial shear strength is determined according to ISO 3327-2009. Products comprising joined carbide and non-carbide materials, in some embodiments, are constructed according to processes described herein.

The carbide material, non-carbide material and interface binder material of a product described herein have compositions and properties consistent with those of processes described herein.

### Example 1

### Joining of Carbide and Non-Carbide Materials

A carbide material of cemented WC was provided comprising 10 weight percent Co binder, and a non-carbide material of H13 steel having a composition in Table I was provided.

TABLE I
H13 Steel

| Element | Mass Percent |
|---|---|
| Carbon | 0.37-0.42 |
| Manganese | 0.20-0.50 |
| Phosphorus | 0-0.025 |
| Sulfur | 0-0.005 |
| Silicon | 0.80-1.20 |
| Chromium | 5-5.50 |
| Vanadium | 0.80-1.20 |
| Molybdenum | 1.20-1.75 |

An interface binder material of a copper strip was positioned between the cemented WC and H13 steel to provide an assembly. The copper strip had a thickness between 0.3 and 10 mm. The assembly was heated under vacuum at a temperature ranging from 1100° C. to 1150° C. to join the cemented WC and H13 steel through a fully dense copper binder layer. The assembly was additionally subjected to hipping during the heating process.

FIGS. 2(A)-(B) are cross-section metallography of the resulting joined cemented WC and H13 steel. As illustrated in FIGS. 2(A) and (B), a fully dense copper interface binder layer joins the cemented WC and H13 steel. An interfacial transition region is evident between the H13 steel and copper interface binder layer in FIG. 2(B).

Several samples of joined cemented WC and H13 steel were produced according to the present example and tested for interfacial shear strength according to ISO 3327-2009. The samples demonstrated interfacial shear strength of 230 MPa with a standard deviation of 25 MPa.

### REFERENCE NUMERALS

| | |
|---|---|
| 1 | Carbide material |
| 2 | Non-Carbide material |
| 3 | Intermediate Interface material |
| 4 | Assembly (Joined Carbide and |
| | Non-Carbide Material) |

### EQUIVALENTS

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

We claim:

1. A process for joining carbide and non-carbide materials comprising:
providing a carbide material;
providing a non-carbide material;
providing an interface binder material comprising a powder metal or powder alloy compact or a sheet of metal or alloy;
positioning the interface binder material between the carbide and non-carbide material to provide an assembly; and
heating the assembly under vacuum or in an inert atmosphere to join the carbide material and non-carbide material through the interface binder material.

2. The process of claim 1, wherein the carbide material is tungsten carbide.

3. The process of claim 2, wherein the carbide material further comprises a metal or alloy binder selected from the group consisting of cobalt, nickel, chromium and alloys thereof.

4. The process of claim 2, wherein the carbide material further comprises one or more elements selected from the group consisting of titanium, niobium, vanadium, tantalum, chromium, zirconium or hafnium.

5. The process of claim 1, wherein the interface binder material is a powdered transition metal compact or a sheet of a transition metal.

6. The process of claim 5, wherein the transition metal is copper.

7. The process of claim 1, wherein the interface binder material is a powdered copper based alloy compact or a sheet of copper based alloy.

8. The process of claim 7, wherein the copper based alloy comprises one or more additive elements comprising nickel, manganese, cobalt or zinc.

9. The process of claim 1, wherein the interface binder material is a powdered silver based alloy compact or a sheet of silver based alloy.

10. The process of claim 9, wherein the silver based alloy comprises one or more additive elements comprising copper, zinc, tin, nickel or manganese.

11. The process of claim 1, wherein the interface binder material has a thickness ranging from 0.3 mm to 10 mm.

12. The process of claim 1, wherein the assembly is heated to a temperature ranging from 1000° C. to 1250° C.

13. The process of claim 1 further comprising subjecting the assembly to hot isostatic pressing.

14. The process of claim 1, wherein heating the assembly provides a substantially fully dense layer of the interface binder material.

15. The process of claim 14, wherein an interfacial transition region is established between the non-carbide material and the layer of interface binder material.

16. The process of claim 15, wherein the interfacial transition region has a thickness ranging from 1 μm to 200 μm.

17. The process of claim 15, wherein the interfacial transition region lacks porosity.

18. The process of claim 14, wherein an interface of the carbide material and the layer of interface binder material lacks porosity.

19. The process of claim 1, wherein the non-carbide material is steel.

20. The process of claim 19, wherein the steel is selected from the group consisting of tool steel, high speed steel and cast iron.

21. The process of claim 1 further comprising grinding or profiling at least one of the joined carbide and non-carbide materials.

22. The process of claim 1, wherein the heating is conducted under vacuum.

23. The process of claim 1, wherein the joined carbide material and non-carbide material has an interfacial shear strength of at least 200 MPa.

24. A product comprising:
a carbide material joined to a non-carbide material according to the process of claim 1.
